(19) United States
(12) Patent Application Publication
(10) Pub. No.: US 2025/0125499 A1
(43) Pub. Date: Apr. 17, 2025

(54) PROTECTION OF ELECTRICAL COMPONENTS IN BATTERY SYSTEMS

(71) Applicant: Aspen Aerogels, Inc., Northborough, MA (US)

(72) Inventors: Christopher Stow, Foxboro, MA (US); Lixin Wang, Belmont, MA (US)

(21) Appl. No.: 18/697,711

(22) PCT Filed: May 4, 2023
(86) PCT No.: PCT/US2023/021023

§ 371 Date: Apr. 1, 2024

Related U.S. Application Data
(60) Provisional application No. 63/338,331, filed on May 4, 2022.

(51) Int. Cl. H01M 50/526; H01M 50/282; H01M 50/503; H01M 50/507; H01M 50/593

(52) U.S. Cl. CPC H01M 50/526; H01M 50/282; H01M 50/503; H01M 50/507; H01M 50/593

(57) ABSTRACT

The present disclosure relates to materials and systems to manage thermal runaway issues in energy storage systems. Exemplary embodiments include an insulated electrical connection element is protected from heat, gases, and/or particulate materials.

### CLAIM OF PRIORITY

This application claims the benefit of priority to U.S. Provisional Patent Application Ser. No. 63/338,331, filed on May 4, 2022, which is incorporated by reference herein in its entirety.

### FIELD OF THE TECHNOLOGY

The present disclosure relates generally to materials, systems, and methods for protection of electrical connection components. In particular, the present disclosure relates to materials, systems and methods for encapsulation of electrical connection components (e.g., a busbar) with an aerogel material. The present disclosure further relates to a battery module or battery pack with one or more battery cells that includes the encapsulated electrical connection components, as well as systems including those battery modules or battery packs.

### BACKGROUND

Rechargeable batteries such as lithium-ion batteries have found wide application in the power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, or operated at or exposed to high temperature and high pressure. As a consequence, narrow operational temperature ranges and charge/discharge rates are limitations on the use of LIBs, as LIBs may fail through a rapid self-heating or thermal runaway event when subjected to conditions outside of their design window.

Thermal runaway may occur when the internal reaction rate increases to the point that more heat is being generated than can be withdrawn, leading to a further increase in both reaction rate and heat generation. During thermal runaway, high temperatures trigger a chain of exothermic reactions in a battery, causing the battery's temperature to increase rapidly. In many cases, when thermal runaway occurs in one battery cell, the generated heat quickly heats up the cells in close proximity to the cell experiencing thermal runaway. Each cell that is added to a thermal runaway reaction contains additional energy to continue the reactions, causing thermal runaway propagation within the battery pack, eventually leading to a catastrophe with fire or explosion. Prompt heat dissipation and effective block of heat transfer paths can be effective countermeasures to reduce the hazard caused by thermal runaway propagation.

Based on the understanding of the mechanisms leading to battery thermal runaway, many approaches are being studied, with the aim of reducing safety hazards through the rational design of battery components.

A typical battery system includes one or more battery modules that each include a plurality of battery cells. Subsets of the battery cells are electrically connected in parallel, and the subsets are electrically connected in series by a series of current collectors (or busbars). For example, terminal current collectors, or busbars, exhibit an electric potential difference that defines a DC bus. Switching components, fuse components, busbars carrying the full voltage of the battery module, any other suitable power electronics, any other suitable components, or any combination thereof may be arranged on or near the battery module(s). A busbar is typically arranged on a side (e.g., the front, back, top, bottom, or any lateral surface) of the battery system for making suitable electrical connections between the components. The busbars tend to extend over a portion of a battery module, and thus may be arranged over one or more battery cells (e.g., venting ends of the battery cells). If a battery cell undergoes a thermal event, adjacent structures, such as a busbar may be damaged. Accordingly, it may be desirable to provide protection from heat, gases, and/or particulate materials.

### BRIEF DESCRIPTION OF THE FIGURES

FIG. 1 shows a top view of a battery system in accordance with some example embodiments.

FIG. 2 shows a busbar in accordance with some example embodiments.

FIG. 3 shows a cross section of a busbar in accordance with some example embodiments.

FIG. 4 shows an isometric view of a battery system in accordance with some example embodiments.

FIG. 5 shows a busbar assembly in accordance with some example embodiments.

FIG. 6 shows a cross section of a busbar assembly in accordance with some example embodiments.

FIG. 7 shows another busbar assembly in accordance with some example embodiments.

FIG. 8 shows another busbar assembly in accordance with some example embodiments.

FIG. 9 shows a battery system in accordance with some example embodiments.

FIG. 10 shows another battery system in accordance with some example embodiments.

FIG. 11 shows another battery system in accordance with some example embodiments.

FIG. 12 shows another battery system in accordance with some example embodiments.

FIG. 13 shows another battery system in accordance with some example embodiments.

FIG. 14 shows another battery system in accordance with some example embodiments.

FIG. 15 shows another battery system in accordance with some example embodiments.

### DETAILED DESCRIPTION

In the following detailed description of the preferred embodiments, reference is made to the accompanying drawings, which form a part thereof, and within which are shown by way of illustration specific embodiments by which the disclosure may be practiced. It is to be understood that other embodiments may be utilized and structural changes may be made without departing from the scope of the disclosure.

The present disclosure is directed to the protection of electrical connection systems in energy storage systems. Exemplary embodiments include protection of busbars in an electrical storage system by the use of aerogel materials.

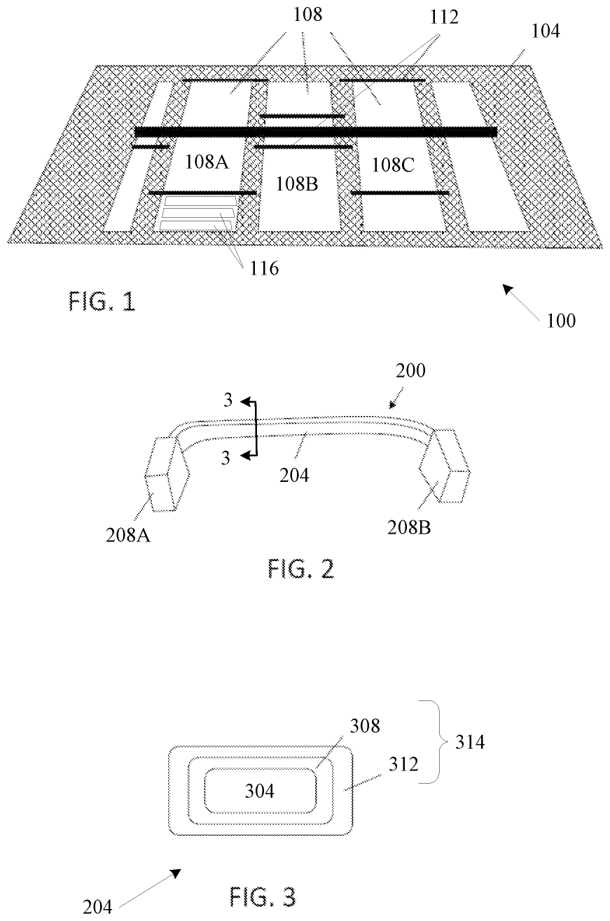

FIG. 1 depicts a schematic diagram of a typical electrical energy storage system 100 that includes a housing 104, battery modules 108A, 108B, 108C (collectively 108), and one or more busbars 112. As described above, the energy storage system 100 may store and release power for use in an electrical vehicle or other electrically powered system.

In the electrical energy storage system 100, the battery modules 108 are disposed inside the housing 104. The battery modules 108 may include multiple individual cells 116 that may be electrically coupled together. In one example, cells 116 include lithium-ion cells, although the present disclosure is not so limited. The one or more busbars 112 of the system 100 electrically connect one or more of the battery modules 108. In some embodiments, a busbar 112 may be an elongated electrically conductive connector that connects terminals from different battery modules or battery cells.

FIG. 2 illustrates a detailed view of one embodiment of a busbar 200, which includes a conductor 204 and plugs 208A, 208B (collectively 208). The conductor 204 may be an electrically conductive, elongate structure configured to span one or more battery modules and/or battery cells to connect corresponding terminals together. In the busbar 200 illustrated in FIG. 2, the conductor 204 is a metal bar. Other instantiations of the busbar 200 may have different configurations of the conductor 204, such as a metal wire, a conductive trace on a structural support, among others. Regardless of its configuration, the conductor 204 acts as the electrically conductive section of the busbar 200. In some examples, the conductor 204 of the busbar 200 may be composed of a conductive metal such as copper, aluminum, or metallic alloys, etc. . . .

The busbar 200 also includes plugs 208A, 208B that are connected to the conductor 204. The plugs 208A, 208B connect the busbar 200 to the terminals of the battery modules or battery cells (not shown in FIG. 2). In one example, the plugs 208A, 208B are configured to engage corresponding features on modules or cells in an energy storage system. One example of a corresponding feature to engage the plugs 208A, 208B includes a slot on a module or cell. Examples of suitable materials for the busbar 200 include electrically conductive metallic materials, such as copper, aluminum, steel, or alloys thereof, etc.

FIG. 3 depicts a cross-sectional view of the conductor 204 of busbar 200 as indicated in FIG. 2. As shown, the conductor 204 includes a conductive core 304, an insulation layer 308, and an encapsulation layer 312. The insulation layer 308 and encapsulation layer 312, collectively referred to as a protective barrier 314, provide aspects of electrical, thermal, and mechanical protection to the conductor 204, thereby improving the overall resiliency and durability of the busbar 200 in response to corresponding electrical, thermal, and/or mechanical stresses/perturbations. The materials of the conductive core 304 correspond to those already described above in the context of the conductor 204 depicted in FIG. 2.

In some embodiments, such as the embodiment illustrated in FIGS. 2 and 3, the protective barrier 314 at least partially covers the conductive core 304. In some embodiments, the protective barrier 314 may cover some or all of a length, a width, and/or any subset of surfaces of the conductive core 304.

In some embodiments, the protective barrier 314 includes at least one insulation layer 308 and at least one encapsulation layer 312. As shown in FIG. 3, at least one of the insulation layers 308 is disposed between the conductive core 304 and an (outer most) encapsulation layer 312. It will be appreciated that different configurations of the protective barrier 314, with greater numbers of one or more of insulation layer 308 and/or encapsulation layer 312 are possible without departing from the concepts described herein. Furthermore, different sequences of layers may also be used to fabricate other embodiments of the protective barrier 314 without departing from the concepts described herein. Although not explicitly shown, the encapsulation layer 314 can surround at least a portion of the plugs 208 (shown in FIG. 2) as well as some or all of the conductive core 304.

In some embodiments, the protective barrier 314 may include an aerogel material as a component within the insulation layer 308 and an encapsulation layer 312 at least partially surrounding the insulation layer.

The insulation layer 308 may include any kind of insulation layer commonly used to separate battery cells or battery modules and that provides thermal insulation, electrical insulation, or both. In some embodiments, the insulation layer(s) 308 may include any one or more of polymer based thermal barriers (e.g., polypropylene, polyester, polyimide, and aromatic polyamide (aramid)), phase change materials, intumescent materials, aerogel materials, mineral based barrier (e.g., mica), and inorganic thermal barriers (e.g., fiberglass containing barriers), or combinations thereof. For example, exemplary insulation layers may include combinations of materials such as an aerogel material or composition and another material such as a mineral-based materials (e.g., mica), phase change materials, or intumescent materials. In such examples, the aerogel material may incorporate the other materials within the aerogel composition or structure. Alternatively, the aerogel material may be disposed adjacent to a layer of the other material, e.g., a layer of aerogel composition adjacent to a layer of a mineral-based material (e.g., mica), a layer of phase change material, or a layer of intumescent material. In further examples, the aerogel material may be disposed between layers of a mineral-based material (e.g., mica), a layer of phase change material, or a layer of intumescent material.

The insulation layer 308 can have a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. at atomospheric pressure and a separately applied mechanical a load of up to about 5 MPa.

In some embodiments, the insulation layer 308 includes an aerogel that further includes a reinforcement material. In some embodiments, the reinforcement material is a fiber selected from organic polymer-based fibers, inorganic fibers, carbon-based fibers or a combination thereof. In some embodiments, the fibers are in the form of discrete fibers, woven materials, dry laid non-woven materials, wet laid non-woven materials, needled nonwovens, battings, webs, mats, felts, and/or combinations thereof. In some embodiments, the inorganic fibers are selected from glass fibers, rock fibers, metal fibers, boron fibers, ceramic fibers, basalt fibers, or combination thereof. In some embodiments, the reinforcement material is a foam selected from siloxanes, polyolefins, polyurethanes, phenolics, melamine, cellulose acetate, oxidized polyacrylonitrile, and polystyrene. In some embodiments, the reinforcement materials are selected from polymeric materials. Non-limiting examples of the polymeric materials are resin, rubber, acrylic (PMMA), acrylonitrile butadiene styrene (ABS), nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU).

In one or more embodiments, the aerogel of the insulation layer 308 includes a silica-based aerogel and/or an alumino-silicate aerogel. In one or more embodiments, aerogel of the insulation layer 308 includes one or more additives, the additives being present at a level of at least about 5 to 40 percent by weight of the aerogel, preferably, at a level of at least about 5 to 20 percent by weight of the aerogel, more preferably, at a level of at least about 10 to 20 percent by weight of the aerogel. In some embodiments, the one or more additives include fire-class additives. In some embodiments, the one or more additives include opacifiers selected from B4C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, or mixtures thereof. In some embodiments, the one or more additives include opacifiers including silicon carbide. In some embodiments, the one or more additives include a combination of fire-class additives and opacifers. In one or more embodiments, the aerogel has a density in the range of about 0.25 g/cc to about 1.0 g/cc. In some embodiments, the aerogel has a flexural modulus of about 2 MPa to about 8 MPa. In some embodiments, the aerogel has a compression set at about 70° C. in the range of about 10% to about 25%. In some embodiments, the aerogel exhibits a compressive resistance, and the compressive resistance at 25% strain is between about 40 kPa to about 180 kPa. In one or more embodiments, the aerogel is in the form of a monolith, beads, particles, granules, a powder, a thin film, a sheet, a plate, a curved plate, or combination thereof.

In some embodiments, the encapsulation layer 312 of the protective barrier 314 may be made from a material that can protect the busbar from the external environment. For example, particulates and fluids (e.g., cooling fluids and battery electrolyte) may be present within the housing of an electrical energy storage system and, absent the encapsulation layer 312, could degrade the electrical and/or thermal performance of the insulation layer 308 and/or the conductive core 304. Furthermore, it is preferred that the encapsulation layer is electrically insulative. This feature can help prevent shorting of the electrical system through the busbars.

In some embodiments, the encapsulation layer 312 may be made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate.

While the encapsulation layer 312 and the insulation layer 308 can combine to protect the busbar from damage due to increased temperatures associated with thermal runaway of a battery cell, some examples of the encapsulation layer 312 and/or the insulation layer 308 may not protect the conductive core 304 from physical impingement of particulate matter from the rupturing battery cell. To improve the ability of the encapsulation layer 312 to withstand mechanical damage from impinging particles, the encapsulation layer 312 may be composed of a toughened polymeric material. In some examples, a toughened polymeric material may include a polymer layer filled with a second phase known to impart improved mechanical properties, thermal properties, and abrasion resistance. One embodiment, a toughening second phase is particles of ceramic materials (e.g., silica nano/microparticles, silicate/clay nano/microparticles). In other embodiment, a toughening second phase isa barrier layer (not shown) embedded in the polymeric material. The barrier layer can be made from a rigid material that inhibits damage from particulate matter hitting the busbar at high speeds. Exemplary materials that can be used for the barrier layer include, but are not limited to, a metal foil, mica, microporous silica, ceramic fiber, mineral wool, metal, carbon, conductive polymer, or combinations thereof.

In addition to busbars, the combination of the insulation layer 308 and the encapsulation layer 312 can also be used to protect other components in the battery pack, such as electrical devices and wirings, coolant tubes, battery cell or pack terminals, temperature sensers, connectors, and/or other components that are vulnerable during thermal runaway.

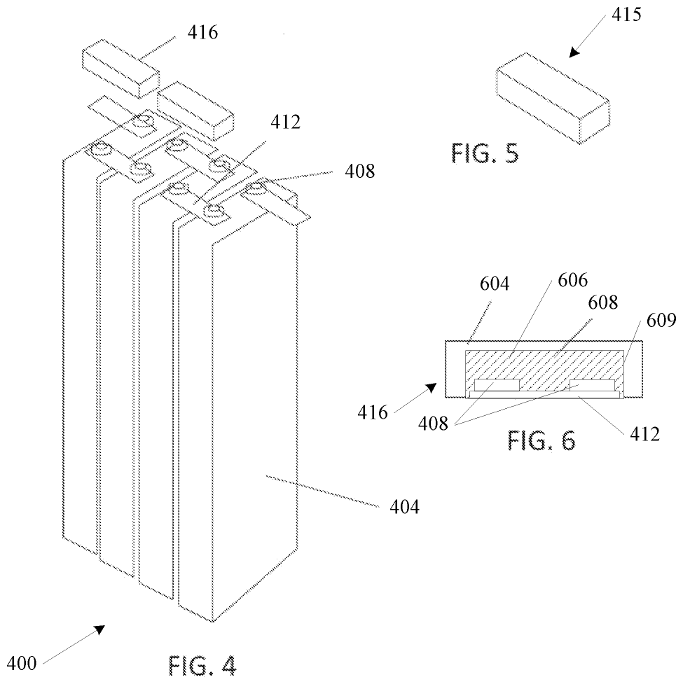

FIG. 4 depicts an embodiment of an electrical energy storage system 400. In this embodiment, the electrical energy storage system 400 includes a plurality of battery cells 404. Each battery cell 404 has two terminals 408 (a positive terminal and a negative terminal). In the embodiment, the battery cells 404 are connected in series, with positive terminals or negative terminals 408 of adjacent battery cells 404 coupled to each other with a busbar 412. The embodiment of the busbar 412 illustrated in FIG. 4 may include any combination and/or subsets of combinations of features described above in the context of FIGS. 1, 2, and 3, or any features described elsewhere herein.

In some embodiments, including the embodiment shown in FIG. 4, the electrical energy storage system 400 may further include a busbar protection assembly 416. The busbar protection assembly 416 may be used to enclose one or more busbars. In some embodiments, one of which is illustrated in FIG. 6, a busbar protection assembly 416 includes a housing 604 having an interior space 606 defined by an interior surface 609 of the housing 604. The busbar protection assembly 416 may also include an insulation layer 608.

The housing 604 of the busbar protection assembly 416 is configured and dimensioned such that the housing 609 is positionable over one or more busbars 412, as shown in FIGS. 4 and 5. When positioned over the busbars 412, the busbars 412 are substantially enclosed by the housing 604.

In an embodiment, the insulation layer 608 may include an aerogel material. The insulation layer 608 may, as shown in FIG. 6, conform to some or all of the interior surface of the housing 609. For example, as shown in FIG. 6, the insulation layer 608 is positioned between the one or more busbars 412 and the interior surface 609 of the housing 604. In an embodiment, the insulation layer 608 covers at least a portion of the interior surface 609 of the housing 604.

In some embodiments, the insulation layer 608 may be made from a resilient material, alone or in combination with an aerogel material. A resilient insulation layer 608 can be compressed by the terminals 408 and causing the insulation layer to conform to the shape of the terminals 408. Therefore, in some embodiments, the insulation layer 608 has a thickness that allows a terminal 408 to fit within the interior space 606 of the housing 604 when compressing the insulation layer 608. In alternate embodiments, the insulation layer 608 has a thickness that allows a battery cell terminal 408 to fit within the interior space 606 of the housing 604 without compressing the insulation layer 608.

The busbar protection assembly can be configured (has a shape and size) that allows the assembly to cover a single busbar or multiple busbars. In some embodiments, the busbar protection assembly covers all of the busbars on the surface of the battery module or battery pack.

In some embodiments, the busbar protection assembly covers the entire surface (e.g., top surface where the busbars are installed) of the battery module or battery pack where the busbars are positioned. In the case where the busbar protection assembly covers the entire surface of the module/pack, the busbar protection assembly provides cushion for the module/pack to potential mechanical impact, in addition to the thermal resisting, fire-resisting, and electrical isolation functions. In this embodiment, the busbar protection assembly is slightly larger than the surface of the battery module/pack to be covered, such that surface of the module/pack with the busbars extends into the busbar protection assembly in a way that the busbar protection assembly surrounds a portion of the battery module/pack. The aerogel lining provides extra cushion for the module/pack.

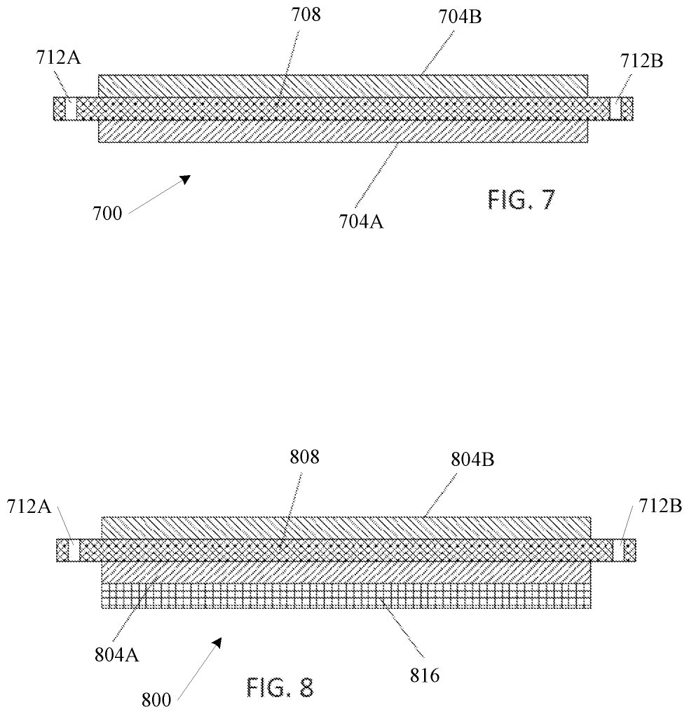

In some embodiments, as depicted in FIGS. 7 and 8, busbars 700 and 800, respectively, may have a laminate structure. In the embodiment of busbar 700 depicted in FIG. 7, the laminate busbar 700 includes one or more insulation layers 704A, 704B, and one or more electrically conductive layers 708. The one or more insulation layers preferably include an aerogel material.

The electrically conductive layers include two or more contact points 712A, 712B (collectively 712) that extend out of the laminated structure and serve as connection regions to connect the busbar to the terminals of adjacent battery cells or battery modules.

In the embodiment depicted in FIG. 7, the insulation layers are disposed as the outer layers of the laminate structure with the one or more electrically conductive layers sandwiched between the insulation layers.

In the embodiment depicted in FIG. 8, the laminate busbar 800 includes the elements described above in the context of laminate busbar 800 (insulation layers 804A, 804B, conductive layer 808) also may also include a barrier layer 816. The barrier layer, as depicted, is positioned below the laminate structure and protects the electrically conductive layers from damage due to particulate matter ejected from battery cells. While depicted as only being on the “bottom” side of the laminate structure, it should be understood that the barrier layer can be on the “top” side of the laminate structure (opposite the battery cell or battery module) or on both sides of the laminate structure.

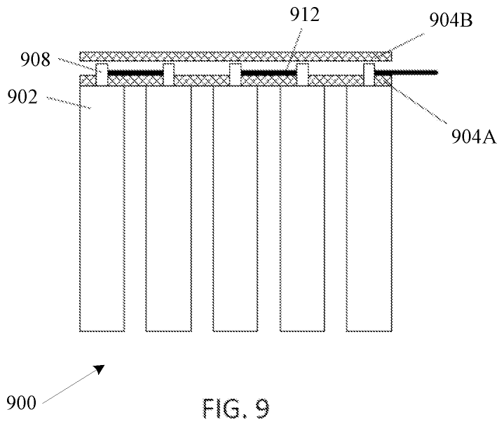

In the embodiment, depicted in FIG. 9, a busbar system 900 includes one or more busbars 912 connecting terminals of adjacent battery cells 902 or battery modules. A first insulation layer 904A is disposed over at least a portion of the battery cells 902 or battery modules. The first insulation layer 904A comprises a plurality of openings. The openings of the first insulation layer are substantially aligned with the terminals 908 of the battery 902 such that the terminals 908 of the battery extend through the first insulation layer 904A and contact the one or more busbars 912. In this embodiment, the first insulation layer 904A protects the busbars 912 from heat produced from a thermal runaway event without the need to modify commercially available busbars.

To further protect the busbars, a second insulation layer 904B can be positioned over the one or more busbars 912. The first insulation layer 904A can be connected to the second insulation layer 904B such that the one or more busbars 912 are substantially surrounded by the first insulation layer 904A and the second insulation layer 904B. In an embodiment, the one or more busbars 912 contact and compress the second insulation layer 904B such that the compressed second insulation layer 904B substantially surrounds the one or more busbars 912.

In an embodiment, the first insulation layer 904A and/or the second insulation layer 904B comprises one or more additional openings aligned with one or more vents present in the battery cells or battery modules. The openings aligned with the vents are typically aligned over vents that are not directly under or near a busbar 912. For vents positioned under one or more of the busbars 912, it is preferred to have a portion of the insulation layer covering the vent such that the insulation layer is positioned between the vent and the busbar.

In an embodiment, the first insulation layer 904A comprises a thermally conductive element coupled to a cooling element. In an embodiment, the thermally conductive element is disposed between the first insulation layer 904A and the battery cells 902. In an embodiment, the thermal conductive element is disposed between the first insulation layer and the second insulation layer. In an embodiment, the thermally conductive element is in direct contact with the busbar.

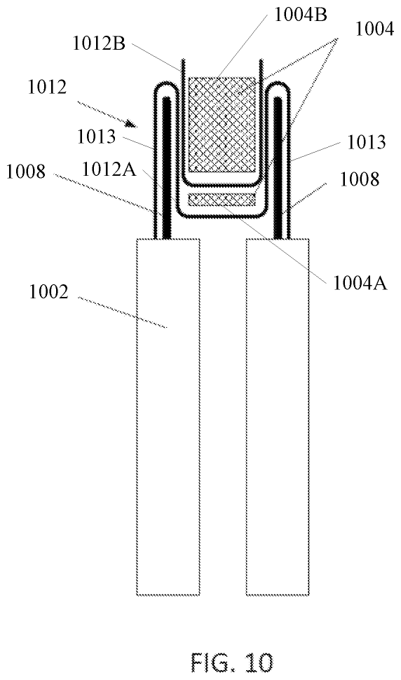

In the embodiment depicted in FIG. 10, a U-shaped busbar 1012 is configured to electrically connect battery cells 1002 or battery modules. The U-shaped busbar 1012 comprises: a first conductive U-shaped section 1012A; a second conductive U-shaped section 1012B; and two channels 1013 for receiving electrode tabs 1008 from adjacent battery cells 1002. During assembly, the second conductive U-shaped section 1012B fits into the first conductive U-shaped section 1012A to secure the electrode tabs 1008 into the two channels 1013. A thermal insulation material 1004 is in contact with the first and/or second U-shaped sections 1012A, 1012B. The thermal insulation material helps protect the U-shaped busbar.

In an embodiment, the thermal insulation material 1004 is positioned over the U-shaped busbar 1012. The thermal insulation material can include a first insulation material 1004A disposed within the inner space defined by the first U-shaped busbar 1012A and a second insulation material 1004B contacting the exterior surface of the second U-shaped busbar 1012B. The second insulation material 1004B extends downward to separate the adjacent battery cells or battery modules. In an embodiment, the first thermal insulation material 1004A comprises a corrugated structure, wherein the corrugated structure is positioned in multiple U-shaped busbars. The insulation material in this embodiment is made from the same materials used to form the insulation layer, as described herein.

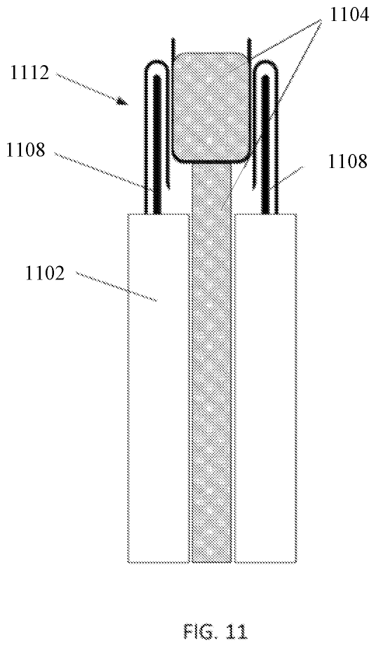

An alternate embodiment is shown in FIG. 11. In this embodiment, the insulation material 1104 that is positioned inside the busbar 1112 is extended out of the busbar 1112 and acts as a separation material between the adjacent battery cells 1102.

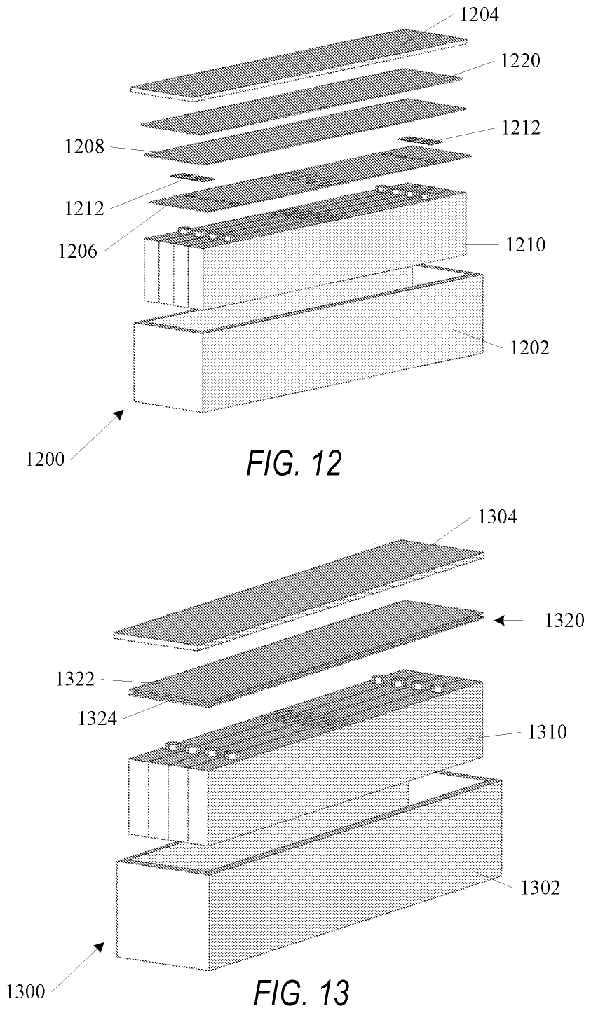

In an embodiment depicted in FIG. 12, a battery module 1200 includes a housing 1202 and a housing lid 1204 to enclose two or more battery cells 1210. The two or more battery cells 1210 are electronically connected by busbars 1212. The busbars are substantially surrounded by a first insulation layer 1206 and a second insulation layer 1208. The battery module further comprises a top cover 1220 adjacent to the second insulation layer 1208. The top cover 1220 protects the housing lid 1204 from damage, for example, due to particulate matter ejected from battery cells 1210 during thermal runaway, thereby containing the thermal runaway within the housing 1202 and lid 1204. In a non-limiting embodiment, the top cover 1220 is positioned between the second insulation layer 1208 and the housing lid 1204. In some embodiments, the top cover 1220 includes one layer with uniform composition. In some embodiments, the top cover 1220 includes an aerogel composition.

In an embodiment depicted in FIG. 13, a battery module 1300 includes a housing 1302 and a housing lid 1304 to enclose two or more battery cells 1310. A top cover 1320 includes an insulation layer 1322 as described with respect to FIGS. 7-11 and a rigid layer 1324 having a higher rigidity than the insulation layer 1322. In some embodiments, the insulation layer 1322 prevents heat transfer through the housing lid 1304. For example, the insulation layer 1322 prevents heat transfer to the housing lid 1304 and components (e.g., car chassis) that may be above the battery module 1300. In another example, the insulation layer 1322 prevents heat loss from the battery module 1300 to the environment during cold weather. In a non-limiting embodiment, the rigid layer 1324 is disposed between the insulation layer 1322 and the battery cells 1310 to protect the insulation layer 1322 from particulate matter that may be ejected from battery cells 1310 during thermal runaway.

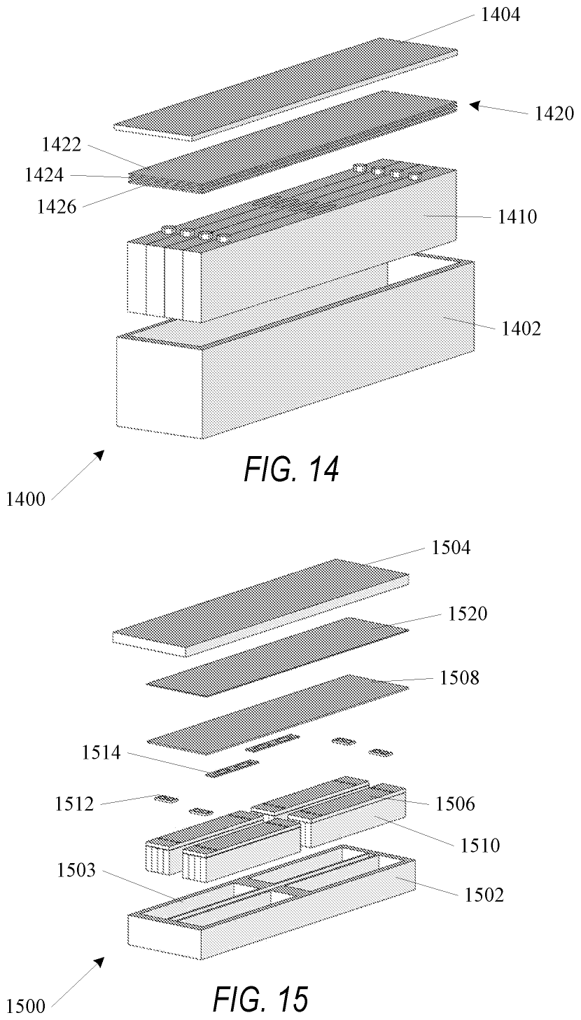

In an alternative embodiment depicted in FIG. 14, a battery module 1400 includes a housing 1402 and a housing lid 1404 to enclose two or more battery cells 1410. A top cover 1420 includes two rigid layers 1422, 1426 and an insulation layer 1424 disposed therebetween. The additional rigid layer 1422 between the insulation layer 1424 and the housing lid 1404 provides better protection than a single rigid layer, with respect to any particulate matter that may be ejected from battery cells 1410 during thermal runaway. In some embodiments, the top cover 1420 may include two or more insulation layers 1424 and rigid layers 1422, 1426. In some embodiments, a rigid layer 1422, 1426 may include the same materials as the barrier layer illustrated in FIG. 8.

In some embodiments, one or more rigid layers 1422, 1426 may be selected from aerogel (e.g., a monolithic aerogel plate), metal foil, mica, microporous silica, ceramic fiber, fiber glass, mineral wool, metal, carbon, conductive polymer, acrylate polymer, polycarbonate, polyester, styrene, vinyl-PVC, cellulose acetate, nylon, phenolics, or combinations thereof.

In an embodiment depicted in FIG. 15, a battery pack 1500 includes multiple battery modules 1510 similar to the modules described in FIG. 12, with the exception that the second insulation layer 1508 extends over to more than one battery modules 1510. In an alternative embodiment (not depicted), each battery module 1510 has a separate second insulation layer 1508. The battery pack 1500 may also comprise busbars 1512 disposed between the first insulation layer 1506 and the second insulation layer 1508 to electrically connect the battery modules 1510. The battery pack 1500 may also comprise secondary busbars 1514 disposed between the first insulation layer 1506 and the second insulation layer 1508 to laterally electrically connect the battery modules 1510. The embodiment of FIG. 15 may also include a top cover 1520, as discussed above in connection with the embodiments of FIGS. 12-14. The top cover 1520 may cover each individual battery module 1510 separately. Alternatively, the top cover 1520 may extend over more than one battery module, as shown in FIG. 15.

As described above, examples of first insulation layers, second insulation layers and top covers may include one or more aerogel composition layers. Other insulation materials apart from aerogels are also within the scope of the present disclosure.

### Use of the Insulation Barriers within Battery Module or Pack

The insulated electrical connectors (e.g., busbars) disclosed herein are useful for electrically connecting battery cells or battery components of batteries of any configuration, e.g., pouch cells, cylindrical cells, prismatic cells, as well as packs and modules incorporating or including any such cells. The electrical connectors disclosed herein are useful in rechargeable batteries e.g. lithium-ion batteries, solid state batteries, and any other energy storage device or technology.

Passive devices such as cooling systems may be used in conjunction with the insulated connectors of the present disclosure within the battery module or battery pack.

The insulated electrical connectors according to various embodiments of the present disclosure can be used in a battery pack including a plurality of battery modules, or in a battery module having a plurality of battery cells. A battery module is composed of multiple battery cells disposed in a single enclosure. A battery pack is composed of multiple battery modules.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

To better illustrate the method and apparatuses disclosed herein, a non-limiting list of embodiments is provided here:

Example 1 is a busbar configured to electrically connect battery cells or battery modules comprising a protective barrier at least partially encapsulating the busbar, wherein the busbar comprises an elongated conductive section and plugs on opposing ends of the elongated conductive section, the protective barrier comprising at least one insulation layer, and optionally an encapsulation layer at least partially surrounding the insulation layer, wherein the insulation layer is positioned between the busbar and the optional encapsulation layer.

Example 2 includes the busbar of Example 1, wherein the protective barrier fully surrounds the elongated conductive section.

Example 3 includes the busbar of any one of Examples 1-2, wherein the protective barrier surrounds at least a portion of the plugs.

Example 4 includes the busbar of any one of Examples 1-3, wherein insulation layer covers one side of the elongated conductive section, and wherein the encapsulation layer fully surrounds the elongated conductive section.

Example 5 includes the busbar of any one of Examples 1-4, wherein the insulation layer has a thermal conductivity through a thickness dimension of said insulation layer of less than about 50 mW/m-K at 25° C. and less than about 60 mW/m-K at 600° C.

Example 6 includes the busbar of any one of Examples 1-5, wherein the insulation layer comprises an aerogel material.

Example 7 includes the busbar of any one of Examples 1-6, wherein the insulation layer further comprises an intumescent material.

Example 8 includes the busbar of any one of Examples 1-7, wherein the insulation layer comprises a reinforcement material.

Example 9 includes the busbar of any one of Examples 1-8, wherein the reinforcement material is a fiber selected from organic polymer-based fibers, inorganic fibers, carbon-based fibers or a combination thereof.

Example 10 includes the busbar of any one of Examples 1-9, wherein the fibers are in the form of discrete fibers, woven materials, dry laid non-woven materials, wet laid non-woven materials, needled nonwovens, battings, webs, mats, felts, and/or combinations thereof.

Example 11 includes the busbar of any one of Examples 1-10, wherein the inorganic fibers are selected from glass fibers, rock fibers, metal fibers, boron fibers, ceramic fibers, basalt fibers, or combination thereof.

Example 12 includes the busbar of any one of Examples 1-11, wherein the reinforcement material is a foam selected from siloxanes, polyolefins, polyurethanes, phenolics, melamine, cellulose acetate, and polystyrene.

Example 13 includes the busbar of any one of Examples 1-12, wherein the encapsulation layer comprises a polymeric material.

Example 14 includes the busbar of any one of Examples 1-13, wherein the encapsulation layer comprises a polymeric material and a barrier layer embedded in the polymeric material.

Example 15 includes the busbar of any one of Examples 1-14, wherein the barrier layer comprises a metal foil.

Example 16 includes the busbar of any one of Examples 1-15, wherein the barrier layer comprises mica.

Example 17 includes the busbar of any one of Examples 1-16, wherein the barrier layer comprises microporous silica, ceramic fiber, mineral wool, metal, carbon, conductive polymer, aerogel powder, or combinations thereof.

Example 18 is a busbar protection assembly configured to at least partially enclose one or more busbars, the busbar protection assembly comprising a housing having an interior space defined by an interior surface of the housing, wherein the housing has a shape and size such that the housing is positionable over one or more busbars, wherein the one or more busbars are substantially enclosed by the housing during use, and an insulation layer positioned inside the housing, wherein the insulation layer is positioned between the one or more busbars and the interior surface of the housing.

Example 19 includes the busbar of Example 18, wherein the insulation layer covers at least a portion of an interior surface of the housing.

Example 20 includes the busbar of any one of Examples 18-19, wherein the insulation layer has a thickness that allows a battery cell terminal to fit within the interior space of the housing without compressing the insulation layer.

Example 21 includes the busbar of any one of Examples 18-20, wherein the insulation layer has a thickness that allows a battery cell terminal to fit within the interior space of the housing when compressing the insulation layer.

Example 22 includes the busbar of any one of Examples 18-21, wherein the busbar protection assembly covers a single busbar.

Example 23 includes the busbar of any one of Examples 18-22, wherein the busbar protection assembly covers multiple busbars.

Example 24 includes the busbar of any one of Examples 18-23, wherein the busbar protection assembly covers all busbars on the surface of a battery module or a battery pack.

Example 25 includes the busbar of any one of Examples 18-24, wherein the busbar protection assembly covers an entire surface of a battery module or a battery pack, the covered surface comprising one or more busbars.

Example 26 includes the busbar of any one of Examples 18-25, wherein the insulation layer provides a cushion between the housing and battery cell terminals or battery module terminals extending into the housing during use.

Example 27 includes the busbar of any one of Examples 18-26, wherein the insulation layer has a thermal conductivity through a thickness dimension of said insulation layer of less than about 50 mW/m-K at 25° C. and less than about 60 mW/m-K at 600° C.

Example 28 includes the busbar of any one of Examples 18-27, wherein the insulation layer comprises an aerogel material.

Example 29 includes the busbar of any one of Examples 18-28, wherein the insulation layer further comprises an intumescent material.

Example 30 includes the busbar of any one of Examples 18-29, wherein the encapsulation layer comprises a polymeric material.

Example 31 includes the busbar of any one of Examples 18-30, wherein the encapsulation layer comprises a polymeric material and a barrier layer embedded in the polymeric material.

Example 32 includes the busbar of any one of Examples 18-31, wherein the barrier layer comprises a metal foil.

Example 33 includes the busbar of any one of Examples 18-32, wherein the barrier layer comprises mica.

Example 34 includes the busbar of any one of Examples 18-33, wherein the busbar is a laminate structure comprising one or more insulation layers, and one or more electrically conductive layers, wherein the electrically conductive layer comprises two or more contact points that, during use, connect the battery cells or the battery modules.

Example 35 includes the busbar of any one of Examples 18-34, wherein the insulation layers are disposed as an outer layer of the laminate structure and wherein the one or more electrically conductive layers are sandwiched between the insulation layers.

Example 36 includes the busbar of any one of Examples 18-35, wherein the laminate structure further comprises a barrier layer coupled to the insulation layer.

Example 37 includes the busbar of any one of Examples 18-36, wherein the laminate structure comprises the following layers, in order from one side to the other side of the laminate structure: a barrier layer; a first insulation layer, an electrically conductive layer and a second insulation layer.

Example 38 includes the busbar of any one of Examples 18-37, wherein the insulation layer has a thermal conductivity through a thickness dimension of said insulation layer of less than about 50 mW/m-K at 25° C. and less than about 60 mW/m-K at 600° C.

Example 39 includes the busbar of any one of Examples 18-38, wherein the insulation layer comprises an aerogel material.

Example 40 includes the busbar of any one of Examples 18-39, wherein the insulation layer further comprises an intumescent material.

Example 41 includes the busbar of any one of Examples 18-40, wherein the encapsulation layer comprises a polymeric material.

Example 42 includes the busbar of any one of Examples 18-41, wherein the encapsulation layer comprises a polymeric material and a barrier layer embedded in the polymeric material.

Example 43 includes the busbar of any one of Examples 18-42, wherein the barrier layer comprises a metal foil.

Example 44 includes the busbar of any one of Examples 18-43, wherein the barrier layer comprises mica.

Example 45 is a busbar system connecting a plurality of battery cells or battery modules, the busbar system comprising a first insulation layer positioned over at least a portion of the battery cells or battery modules, the first insulation layer comprising a plurality of openings, and one or more busbars electrically connecting one or more battery cells or battery modules, wherein the openings of the first insulation layer are aligned with the terminals of the battery, such that the terminals of the battery extend through the first insulation layer and contact the one or more busbars.

Example 46 includes the busbar of Example 45, further comprising a second insulation layer positioned over the one or more busbars.

Example 47 includes the busbar of any one of Examples 45-46, wherein the first insulation layer is connected to the second insulation layer such that the one or more busbars are substantially surrounded by the first insulation layer and the second insulation layer.

Example 48 includes the busbar of any one of Examples 45-47, wherein the one or more busbars contact and compress the second insulation layer such that the compressed second insulation layer substantially surrounds the one or more busbars.

Example 49 includes the busbar of any one of Examples 45-48, wherein the first insulation layer and/or the second insulation layer comprises one or more additional openings aligned with one or more vents present in the battery cells or battery modules.

Example 50 includes the busbar of any one of Examples 45-49, wherein the one or more vents are not under the one or more busbars.

Example 51 includes the busbar of any one of Examples 45-50, wherein at least some of the one or more vents are positioned under the one or more busbars, and wherein the first insulation layer is positioned between the one or more vents when the vents are positioned under the one or more busbars.

Example 52 includes the busbar of any one of Examples 45-51, wherein the first insulation layer comprises a thermally conductive element coupled to a cooling element.

Example 53 includes the busbar of any one of Examples 45-52, wherein the first insulation layer and/or the second insulation layer comprises an aerogel material.

Example 54 is a U-shaped busbar configured to electrically connect battery cells or battery modules, wherein the busbar comprises a first conductive U-shaped section, a second conductive U-shaped section, two channels for receiving electrode tabs from adjacent battery cells wherein the second conductive U-shaped section fits into the first conductive U-shaped section to secure the electrode tabs into the two channels, and a thermal insulation material in contact with the first and/or second U-shaped sections.

Example 55 includes the U-shaped busbar of Example 54, wherein the thermal insulation material is positioned over the U-shaped busbar.

Example 56 includes the U-shaped busbar of any one of Examples 54-55, wherein thermal insulation material comprises a first insulation material disposed within the inner space defined by the U-shaped busbar and a second insulation material contacting the exterior surface of the U-shaped busbar.

Example 57 includes the U-shaped busbar of any one of Examples 54-56, wherein the second insulation material extends downward to separate the adjacent battery cells or battery modules.

Example 58 includes the U-shaped busbar of any one of Examples 54-57, wherein the second insulation material extends downward through an opening on the bottom of the first conductive U-shaped section.

Example 59 includes the U-shaped busbar of any one of Examples 54-58, wherein the first thermal insulation material comprises a corrugated structure, wherein the corrugated structure is positioned in multiple U-shaped busbar.

Example 60 includes the U-shaped busbar of any one of Examples 54-59, wherein the thermal insulation material comprises an aerogel.

Example 61 includes a battery module comprising a plurality of battery cells, a housing and a housing lid to contain the plurality of battery cells, and an insulation layer between housing lid and the plurality of battery cells.

Example 62 includes the battery module of Example 61, wherein the insulation layer includes aerogel.

Example 63 includes the battery module of any one of Examples 61-62, further including a barrier layer between the plurality of battery cells and the housing lid.

Example 64 includes the battery module of any one of Examples 61-63, wherein the barrier layer is between the insulation layer and the housing lid.

Example 65 includes the battery module of any one of Examples 61-64, wherein the barrier layer is chosen from a material chosen from metal foil, mica, microporous silica, ceramic fiber, mineral wool, metal, carbon, conductive polymer, or combinations thereof.

Example 66 includes the battery module of any one of Examples 61-65, further comprising one or more busbars or busbar systems according to any one of the claims 1-60.

Example 67 includes the battery module of any one of Examples 61-66, wherein the top cover is configured to resist damage from particulate matter ejected from battery cells.

Example 68 includes the battery module of any one of Examples 61-67, wherein the top cover comprises a rigid layer and an insulation layer.

Example 69 includes the battery module of any one of Examples 61-68, wherein the top cover comprises a metal foil or mica.

Example 70 is an electrical power system comprising one or more battery modules as described in Example 61.

Example 71 is a device or vehicle comprising a battery module according to Example 70.

Example 72 includes the device of Example 71, wherein the device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool.

Example 73 includes the device of Example 71, wherein the vehicle is an electric vehicle.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, systems, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1-19. (canceled)

20. A battery module comprising:
a plurality of battery cells,
a housing and a housing lid to contain the plurality of battery cells, and
an insulation layer between the housing lid and the plurality of battery cells.

21. The battery module of claim 20, wherein the insulation layer includes aerogel.

22. The battery module of claim 20, further including a barrier layer between the plurality of battery cells and the housing lid.

23. The battery module of claim 22, wherein the barrier layer is between the insulation layer and the housing lid.

24. The battery module of claim 22, wherein the barrier layer is chosen from a material chosen from metal foil, mica, microporous silica, ceramic fiber, mineral wool, metal, carbon, conductive polymer, or combinations thereof.

25. The battery module of claim 20, wherein the insulation layer comprises a plurality of openings and the plurality of battery cells comprise terminals, and wherein the terminals extend through the openings.

26. The battery module of claim 20, wherein the insulation layer comprises a plurality of openings and the plurality of battery cells comprise vents, and wherein the openings are aligned with the vents.

27. The battery module of claim 20, wherein the battery module further includes a laminated busbar, and wherein the laminated busbar includes the insulation layer.

28. The battery module of claim 27, wherein the plurality of battery cells comprises vents, and wherein the insulation layer is positioned between the vents and the busbar.

29. The battery module of claim 28, wherein the insulation layer comprises a plurality of openings aligned with the vents, and wherein the vents are misaligned with the busbar.

30. The battery module of claim 20, wherein the insulation layer is a first insulation layer, and wherein the battery module further comprises a second insulation layer between the housing lid and the plurality of battery cells.

31. The battery module of claim 30, wherein the battery module further includes a laminated busbar, and wherein the laminated busbar includes the first insulation layer, the second insulation layer, and a conductive layer between the first and the second insulation layer.

32. The battery module of claim 31, wherein the plurality of battery cells comprises terminals, and wherein the conductive layer extends out of the first and second insulation layer to connect the busbar to the terminals.

33. The battery module of claim 31, wherein the conductive layer contacts and compresses the second insulation layer such that the compressed second insulation layer surrounds the conductive layer.

34. The battery module of claim 31, wherein the first insulation layer is connected to the second insulation layer such that the conductive layer is surrounded by the first insulation layer and the second insulation layer.

35. The battery module of claim 22, wherein the barrier layer is between the insulation layer and the plurality of battery cells.
